(19) United States
(12) Patent Application Publication
(10) Pub. No.: US 2011/0106618 A1
(43) Pub. Date: May 5, 2011

(54) APPARATUS AND METHOD FOR TARGETED ADVERTISEMENT

(76) Inventor: Sagi Ben-Moshe, Kiryat Bialik (IL)

(21) Appl. No.: 12/922,192

(22) PCT Filed: Oct. 7, 2008
(86) PCT No.: PCT/IL08/01335

§ 371 Date: Jan. 18, 2011

Related U.S. Application Data
(60) Provisional application No. 61/035,747, filed on Mar. 12, 2008.

(51) Int. Cl. G06Q 30/00; G06Q 90/00

(52) U.S. Cl. 705/14.49; 705/500; 705/14.4; 705/14.68

(57) ABSTRACT

A system and method for targeted advertisement that includes embedding the content of the advertisement with the existing displayed content, which is optionally and more preferably broadcast video content. For example, the present invention relates to embedding advertising content within broadcast video content displayed on television screens. The system features a receiver that is connected to the video input and video output of the television set and can inject advertisements to the display. The advertisements are optionally selected according to a bidding algorithm that is preferably performed by an external server or other remote device; however, it is also possible that they are selected according to a different, non-bidding mechanism. The advertiser and/or the owner of the resource displaying the advertisement may optionally select or request the advertisement for display.

### FIELD OF THE INVENTION

The present invention relates to targeted advertisements and in particular to targeted visual advertisements, such as advertisements displaying on television screens or any other type of electronic screen.

### BACKGROUND OF THE INVENTION

The usage of television has become very popular. Televisions can be found in almost every house. Due to the great exposure on television, the advertising on this media has become a useful tool for prompting product purchases and other business activities. An advertiser desires to maximize revenue by enticing a viewer to purchase the product or services displayed in its advertisement. Hence, advertisers are willing to pay more if the advertisement targets viewers that are more likely to purchase the advertiser's products or services. New techniques have been developed for increasing the revenue from the advertisements both for the businesses and for the advertising companies. Such techniques comprise targeting the advertisements based on the user's profile and the content being displayed.

Many businesses also feature televisions in order to entertain the customers. Such businesses can be, for example, restaurants, pubs, doctors' offices, hospitals, health clubs, banks and the like. Displaying targeted advertisements on television screens of small businesses can provide revenues for the business owner and the advertiser. Unfortunately there is no such targeting option in the present art.

US Patent Application No. 20070124762 describes a method for targeting advertisement based on the content being viewed. For example, targeting the advertisement based on the current scene or according to demographic criteria such as the profile of the user. The method also enables the user to control the advertisements being displayed. However, the taught method does not teach how to target the advertisement without user intervention.

U.S. Pat. No. 7,136,871 describes a system, including a planning module, a control module and a receiver module, configured to schedule the display of one or more advertising impressions of available advertising inventory. The planning module enables scheduling of a requested quantity of advertising impressions in accordance with target criteria. Further, the planning module enables selecting an advertising impression goal for advertisement, assigning an advertising type and defining a weight for the advertisements. The control module receives the schedule, the advertising type and the defined weights and generates one or more metadata files that contain target criteria, advertising type and weights for the advertisements. The one or more metadata files, with the advertisements, are delivered to the receiver module that is configured to define a display frequency for the advertisements based upon one or more of the metadata files. The receiver module selectively displays advertisement content associated with the advertisements to achieve the advertising impression goal. Unfortunately this patent does not teach sufficiently precise targeting of the advertisements.

US Patent Application No. 20070283384A1 describes a method of providing targeted advertisements by receiving video content of television programming at a set-top box device from a video server of an Internet Protocol Television (IPTV) system, and also receiving video content of a targeted advertisement at the set-top box device from the same video server, wherein an advertisement server of the IPTV system selects the targeted advertisement based on a customer profile associated with an identifier of the set-top box device. The system recognizes an advertisement insertion point in the video content of the television programming and inserts the video content of the targeted advertisement into the video content of the television programming at the advertisement insertion point. Unfortunately this system selects the targeted advertisement based on customer profile only and is geared towards the IP-TV market only, such that the advertisement must be provided with the video content itself.

US Patent Application No. 20040078809 describes a system for targeting advertisements comprising a set box having a processor that is operable to read a plurality of viewer characteristics relating to an image that is currently being viewed. These viewer characteristics are typically provided by the television broadcaster or another remote data center. The viewer characteristics are used to construct a multi-dimensional viewer profile. Each time the viewer views a television program, the information in the viewer profile is updated. In order to target adverts at specific viewers, the viewer profile is compared with a multi-dimensional target viewer profile associated with an advert. In the event that there is a sufficient match, the advert is displayed on the television screen. Unfortunately the targeting is focused on the viewer profile only.

US Patent Application No. 20020042914 describes an interactive television application in which advertisements are targeted based on current media. Targeted advertisements may be displayed in displays such as program guide information screens and video overlays. Advertisements are targeted and selected for display or excluded from display based on identifying which advertisements are associated with a current media or recently watched media. Media groupings are provided to associate media with groups of advertisements. Selection of advertisements for each media grouping can be based on programs, channels, network affiliation, sponsorship, genre or other suitable criteria. Unfortunately the targeting is focused on the viewer profile only.

PCT Application No. WO 2008/058298 A2 discloses a system and method for allocating digital content in real time, including processing sign, sales and buying parameters for digital sign in a sign database. According to this application, the digital sign owner may access the database for reviewing digital content and saving the content in a database. The application features a method for processing bidding parameters for a time slot on a digital sign, auctioning the time slot to providers of the approval digital content, distributing the digital content to digital sign and airing wining digital content during the time slot. Unfortunately this application does not relate to broadcast content for televisions but only for signs.

Bidding has become a popular method for determining the price paid for advertisement slot on the internet.

One example of a bidding method is “the second price auction” or “Vickrey Auction”. A Vickrey auction is a type of sealed-bid auction, where bidders submit written bids without knowing the bid of the other people in the auction. The highest bidder wins, but the price paid is the second-highest bid and the winner cannot play in later spots.

This second price model is not stable in many to many auctions, with many bidders and many resources, since the agent winning the best spot may gain less utility than the agent winning the second spot, as the following example shows:

The following example clarifies the deficiencies of this model in the many to many auction model. The example features three cell companies and two spot groups. Each of the companies has an evaluation for each of the spots as follows:

| Company | 1^{st} sp | 2^{nd} sp |
|---|---|---|
| Red Cell | 110$ | 80$ |
| Blue Cell | 90$ | 70$ |
| Green Cell | 70$ | 10$ |

Red Cell wins spot one, paying ninety, and Blue cell wins spot two, paying ten. The utility of Red cell is twenty dollars, whereas the utility of Blue cell is sixty dollars. In order to increase its utility Red Cell can lie about its true evaluations, and say that spot one is worth only eighty five dollars, thereby receiving the second spot at a much lower price, as Blue Cell would pay $85 for the first spot (utility of $5) while Red Cell would only pay $10 for the second spot (utility of $70). Thus this method is not inherently honest and stable.

### SUMMARY OF THE INVENTION

There is an unmet need for, and it would be highly useful to have, a system, an apparatus and a method for targeted advertisement in public displays such as television screens in public places and the like, based on content that is displayed on the public display or and based on the type or and the location of the owner of the public display screen.

There is an unmet need for, and it would be highly useful to have a method for advertising in real time on a public display screen and receiving analytics regarding the advertising campaign in real time on public display screens. By real time it is meant that the publisher can advertise on public display screen in seconds and see the advertisement on the public display screen immediately and get reports on the advertising like price, location and time of the advertisement in seconds.

There is unmet need for, and it would be highly useful to have a method for generate revenue from public display screens. By generate revenue it is meant that the owner of the public display screen can earn money from using the public display screen as an advertisement platform.

There is also an unmet need for, and it would be highly useful to have, a method for providing truthful and stable solution for the bidding for a many to many auction. By many to many auctions it is meant that many publishers want to advertise on many public display screens, and the price is decided by the auction algorithm. By stability it meant that all bidders are satisfied with the result and do not wish to change their strategy. By truthfulness it is meant that it is not worthwhile for bidders to lie about their evaluations.

The present invention overcomes these deficiencies of the background art by providing a system, a method and apparatus (receiver) for targeted advertisements which are customized to the requirements of the publisher and/or to the business owning the television set, such as a pub, health club, hospital, casino and the like, to the nature of the observers who watch this television show and optionally to the nature of the displayed show. The receiver is optionally and preferably connected to an existing television monitor and is able to embed targeted textual, video or audio advertisement messages into existing television broadcasts. These messages are custom fitted to the requirement of the owner of the television set such as a pub, health club, hospital and the like and to the nature of the observers, which may optionally be determined according to the type of business, the location of the business and so forth, as well as optionally according to the type of content being shown (which is presumed to impact on the type of individuals viewing the content).

The advertiser can benefit from targeting the advertisement to the nature of the observers who watches this television and to the location of the place. In addition, the advertisement can change dynamically according to the nature of the shows watched. For example, a barbershop that is located nearby a pub can benefit from advertising his business in this pub when a football show is displayed.

According to embodiments of the present invention, the owner of the television can optionally define the nature of messages to be received, or alternatively or additionally, may optionally define the nature of messages which should not be received, and thus guarantees that the messages hosted by its television screens will not interfere with its regular business course. Examples for owner's requirements include but are not limited to no alcohol advertisements, only narrow textual slides, allows video messages but for no longer than two minutes per hour and the like. In addition, the messages can optionally and preferably automatically be adjusted according to the nature of a business: for example, beer and wine advertisements for pubs, organic food and sports equipment for health clubs and the like. This embodiment increases impact for the advertisers and provides a new income source for the host (owner of the television).

According to another embodiment of the present invention, the advertiser can optionally and preferably define the public display in which the advertisement will be displayed. For example, a local barbershop may ask to advertise a special deal for two haircuts for the price of one, in pubs located in its local town, in the evening hours of Sundays. Many small businesses, which were not able to afford TV advertisement hitherto, would therefore have the possibility of accessing, their potential customers through television advertising with a relatively small advertisement budget.

According to other embodiments of the present invention, the system provides a bidding mechanism for deciding which advertisement is to be displayed. The system preferably provides a plurality of different groups of bidding, of which non-limiting examples include On Resource bids, On Channel bids and On Event Bids. Bids of the first kind allow the advertiser to bid for time slots based on fixed characteristics such as business type, physical location of the business and the like. “On Event” bidding allows bids to be placed on specific events that happen in real time (for example a specific game or other event that is shown). Bids for a particular television or other video broadcasting channel form the second type of bidding, as On Channel bids.

On resource bids are preferably divided into two groups: bidding on specific resource or bidding on a group of resources. On resource bids may optionally be performed on a single resource or alternatively a plurality of resources.

In the case of bidding on a resource group, the resources are preferably divided into groups such as pubs, restaurants health club places and the like. Each resource is preferably specified by its name and location or other parameters like the numbers of viewers for this public display screen. For bidding on a resource group, rather than bidding for an individual business location and/or television (or resource) the bidding preferably features a plurality of such resources, for example the bidding can be on all restaurants in Manhattan or on a campaign having a greater weight in a particular group, such as a particular mixture of geographical locations (for example, 70% Manhattan, 30% Chicago, or a range of such percentages). Thus the advertiser preferably provides the location and the resource group in addition to all the other parameters. According to this embodiment the advertiser's budget is preferably distributed between various resources according to an algorithm which maximizes the exposure of the advertiser, preferably while maintaining any requested constraints of the advertiser.

According to this embodiment, the advertising on each resource is optionally and preferably divided into time slots (intervals). Each time slot on each resource or group of time slots preferably and optionally has its own advertising price. Advertising at peak hours (for example during the afternoon for a haircut or other hair salon activity, or at night in a pub) is preferably more expensive than advertising at other, non-peak times. The price may optionally be defined according to the advertisement itself, rather than the time slot. For example, a Video advertisement can have a different price from Text advertisement or Audio advertisement.

The time slots may optionally be determined for each specific public display screen or for a plurality of screens, for example all screens at a particular location (restaurant or pub for example), or within a particular geographical area and so forth.

On Event Bids are bids for real time events. These events can start at any time and may optionally have a duration which is not defined in advance, such that the start and/or ending times of the event may also not be defined in advance. Such events may optionally be contained within another event, for example, a goal in a football game, or choosing a winner in a game and the like. For these types of events the division into predetermined time slots cannot be used. Each resource owner can optionally choose in which events the display that is under his ownership will participate, although alternatively there is no explicit selection. There may optionally be an implicit selection by only showing the correct, channel and allowing the injection of advertisements in the event time slot, although this is also not required. For example an owner of a pub can choose not to participate in a beauty contest, while the owner of a hair salon for women might choose not to participate in a football game event. The on event bids preferably allow the advertiser to choose the advertisement, the budget, and optionally one or more of the specific resource, the event, the time slot, which is in intersection with the event start and end time and Dollar per Minute Limit (DPML), as well as optionally per campaign. By “DPML” it is meant any monetary limit per unit of time. The bid is preferably performed when the event occurs and preferably comprises of all the bids that are to be performed within the event time frame.

On Channel bids may optionally be implemented as for on Event bids, with the definition of an “event” as specific channel shown on the public display screen at a specific time slot.

Similarly, the on channel and on resource bids preferably allow the advertiser to choose the advertisement, the budget, and optionally one or more of the specific resource, the event (if it exists), the time slot, which is in intersection with the event start and end time and Dollar per Minute Limit (DPML), as well as optionally per campaign. By “DPML” it is meant any monetary limit per unit of time. The latter parameter allows the advertiser to monitor cost so that the advertisement is not shown if the charge per minute is higher than the limit. Parameters relating to the time slot and so forth are preferably “soft constraints” which are not necessarily maintained.

According to other embodiments of the present invention, the advertisements may optionally be obtained from various resources such as a dedicated database, or optionally through a web based interface, SMS message or any other type of interface, for example an HTTP based interface. Optionally and preferably, the advertisements are provided through a web based interface. Also optionally and preferably, the bidding process occurs through a web based interface.

According to some embodiments of the present invention, the owner of a resource may optionally request that a particular advertisement be displayed on the public display associated with that resource, for example to show an advertisement of the owner's own location, optionally including a special event thereto.

According to some embodiments of the present invention, it is possible to easily enter an advertisement through a web-based interface, or any other type of interface, which may then be displayed on the requested public displays and/or type of displays as described herein. The request may optionally be done in a single simple process. Thus, an advertiser can easily select the location(s) for display of an advertisement, or any other characters; the advertisement would then be displayed immediately if selected by the bidding process, and the publisher may receive detailed reports on the publisher's advertisements, preferably rapidly (within seconds, minutes, hours, days, weeks, months and so forth) which is currently not possible without the present invention.

Without wishing to be limited by a single hypothesis or description, the present invention overcomes the deficiencies of previously available many to many auction models, by providing a solution which is more stable and which encourages proper (ie truthful) bidding, for any type of bidding mechanism, including for example Vickery auctions.

Although the present invention is described with regard to a “television”, it should be noted that any public electronic display, including but not limited to a screen, movie screen, other video display screen, an electronic game of chance featuring video content and the like may be described as a television.

As used herein, the term “broadcast” refers to a video or other television signal, which is transmitted to many televisions or other receivers, preferably from a cable or air television signal broadcaster, or from IPTV or another television broadcaster through a computer network such as the Internet, with the proviso that it does not include transmission of Flash video or other embedded known types of media inside the web browser, such as transmission from a video sharing website such as YouTube® for example. If transmission is not described as being “broadcast” then it may optionally may feature locally provided content which is not transmitted from a remote location and/or which is specific to the location having the display screen. For example, a pub may provide a viewing of a DVD movie or other local media to the local audience.

As used herein, the term “advertisement” refers to any type of text, audio, video, animation, Flash or any other type of media, or one or more content items or other data which may be converted to the advertisement at the receiver connected to the public display. The data may optionally be sent “piggy backed” on the transmission of the actual content to be displayed.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

By “online”, it is meant that communication is performed through an electronic and/or optic communication medium, including but not limited to, telephone data communication through the PSTN (public switched telephone network), cellular telephones, IP network, ATM (asynchronous transfer mode) network, frame relay network, MPLS (Multi Protocol Label Switching) network, any type of packet switched network, or the like network, or a combination thereof; data communication through cellular telephones or other wireless or RF (radiofrequency) devices; any type of mobile or static wireless communication; exchanging information through Web pages according to HTTP (HyperText Transfer Protocol) or any other protocol for communication with and through mark-up language documents or any other communication protocol, including but not limited to IP, TCP/IP, UDP and the like; exchanging messages through e-mail (electronic mail), instant messaging services such as ICQ™ for example, and any other type of messaging service or message exchange service; any type of communication using a computer as defined below; any type of computer network, such as a LAN (local area network), WAN (wide area network), MAN (metropolitan area network), intranet, Internet and the like, as well as any other type of communication which incorporates an electronic and/or optical medium for transmission. The present invention can be implemented both on the interne and the intranet, as well as on any type of computer network.

Although the present invention is described with regard to a “computer” on a “computer network”, it should be noted that optionally any device featuring a data processor and memory storage, and/or the ability to execute one or more instructions may be described as a computer, including but not limited to a PC (personal computer), a server, a minicomputer, a cellular telephone, a smart phone, a PDA (personal data assistant), a pager, TV decoder, VOD (video on demand) recorder, game console or other dedicated gaming device, digital music or other digital media player, ATM (machine for dispensing cash), POS credit card terminal (point of sale), electronic cash register, or UMPC (Ultra Mobile Personal Computer). Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a schematic drawing of an exemplary embodiment of the system according to the present invention, while FIG. 1B shows an exemplary method according to the present invention for the advertisement display process;

FIG. 2 is an exemplary flow describing the scenario in which a receiver identifies key event;

FIG. 3 is an exemplary flow describing the scenario of On Resource bid;

FIG. 4 is an exemplary picture of a television display;

FIG. 5 is an exemplary scenario for configuring the resource parameters in the server;

FIG. 6 is a description of an exemplary bidding algorithm;

FIG. 7 shows an exemplary embodiment of a method for permitting the owner of a resource to cause a particular advertisement to be displayed through the resource;

FIG. 8 shows an exemplary embodiment of a method for selecting one or more advertisements for display in real time.

FIG. 9 is a diagram describing the architecture of the system.

FIG. 10 is a diagram describing the event bid handler according to one embodiment of the system.

FIG. 11 is a diagram describing the slice manager according to one embodiment of the system.

FIG. 12 is a diagram describing the real time manager according to one embodiment of the system.

FIG. 13 shows a flow chart of an exemplary method for interaction between wireless devices, such as cellular telephones, and the system of the present invention in some embodiments, through SMS messages.

### DETAILED DESCRIPTION

The present invention is of a system and method for targeted advertisement that includes embedding the content of the advertisement with the existing displayed content, which is optionally and more preferably broadcast video content. For example, the present invention relates to embedding advertising content within broadcast video content displayed on television screens. The system features a receiver that is connected to the video input and video output of the television set and can inject advertisements to the display. The advertisements are optionally selected according to a bidding algorithm that is preferably performed by an external server or other remote device; however, it is also possible that they are selected according to a different, non-bidding mechanism. The advertiser and/or the owner of the resource displaying the advertisement may optionally select or request the advertisement for display.

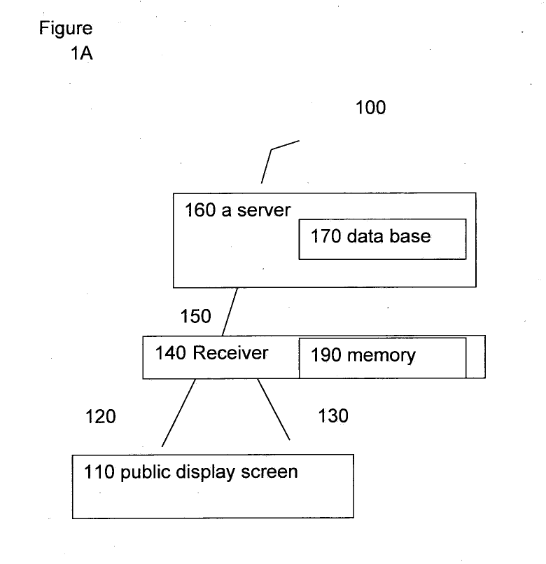

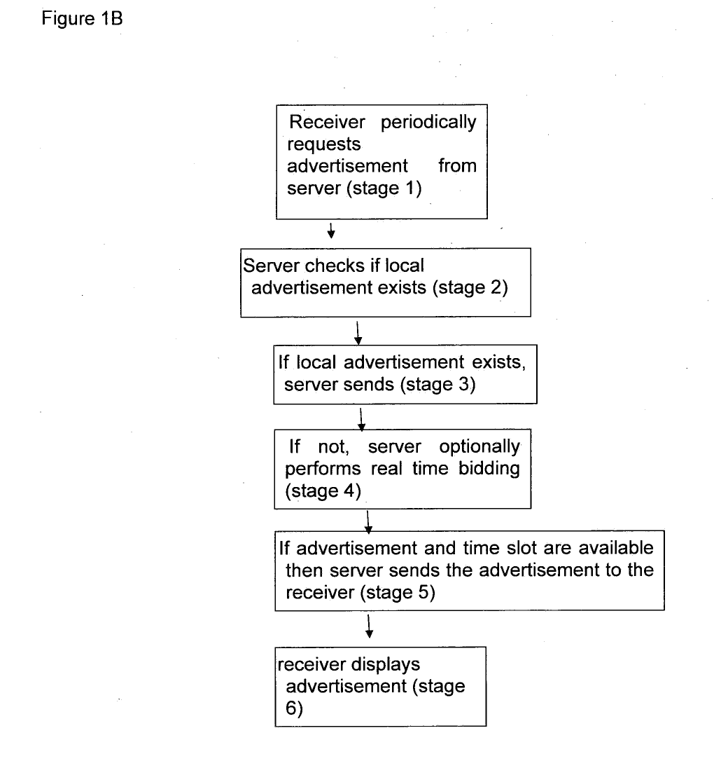

FIG. 1A is a schematic block drawing of an exemplary embodiment of the system. The system provides targeted advertisement which is custom fitted to the requirement of the business owning the television set, such as a pub, health club, casino, hospital, and the like, optionally to the nature of the observers who watch this television show and optionally to the nature of the displayed show. System 100 features a receiver 140, which is preferably connected to a public display screen (such as a television) 110 and a server 160. Receiver 140 is connected to the display, and its output is directed to the TV-in input of the display. Receiver 140 preferably controls television signal, for example by providing it to display screen 110.

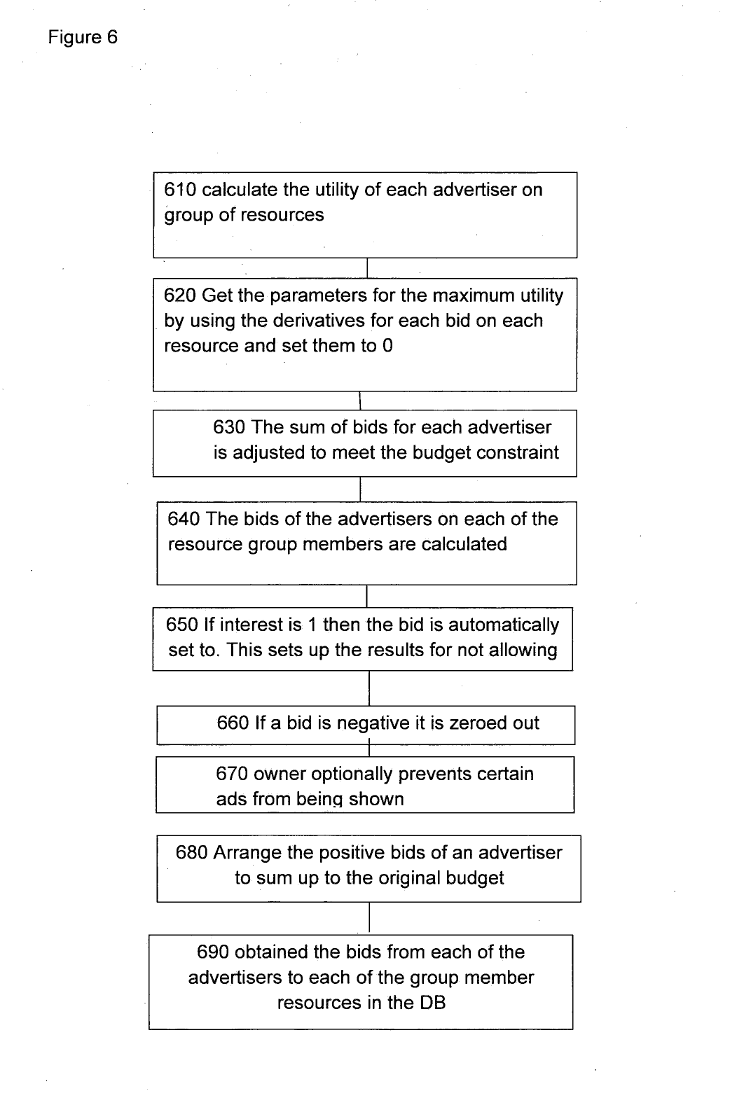

Receiver 140 optionally and preferably monitors the television signal, through input channel 120 for identification of key events. Such key events can be, for example, a football or soccer game, a singer show and the like. Preferably the information regarding the key event is received from the broadcaster responsible for providing the television signal. Optionally, once a key event has been defined, the receiver 140 preferably classifies the signal as belonging to the key event and transmits the information to server 160. Receiver 140 may also optionally send one or more images to server 160, for example for identification purposes, to identify the key event. Receiver 140 may also optionally and preferably request an additional advertisement periodically from server 160 even without identification of key events. Server 160 optionally returns commercial activation signals, together with the relevant advertisement data. The advertisement data is optionally and more preferably chosen according to an exemplary bidding algorithm which is explained in FIG. 6.

Once the advertisement data is received, receiver 140 performs real-time video processing for the smooth insertion of the advertising message, through channel out 130, for example according to alpha blending of the video data. The process of identifying the signal may optionally be performed with a machine learning engine.

Receiver 140 and server 160 are preferably connected via standard communication channels 150, such as the internet, a cellular communication network or indeed any type of computer network, for example. Receiver 140 features at least the following input channels: a standard communication channel for receiving main video input from the television broadcast connection; a standard communication channel for sending video output to the television display screen 110; a standard communication channel for I\O operations with the server, which is optionally for IP communication. Any type of video in or video out data formats may optionally be used.

Receiver 140 optionally features memory 190 for storing the advertisements to be displayed. Receiver 140 optionally features video processing functionality like alpha blending, transformations, color gradient adjustment and the like. Advertisements are optionally and preferably stored in compressed mode. Receiver 140 preferably features at least the following output channels: a standard communication channel for sending main video input to the hosting device and a standard communication channel, such as an IP channel for example, for I\O operations with the server. Server 160 optionally features one or more databases 170 for storing the bidding criteria and optionally also advertisements. Alternatively, bidding criteria can be stored in a separate database which optionally is connected to server 160 via network. Server 160 preferably receives signals from multiple receivers 140 which are connected to server 160 via a network, more preferably using an IP connection (for example through the Internet; optionally and most preferably using HTTP). Server 160 or other server via the network operates the bidding algorithm for finding the advertisements to be displayed on the display screen 110 that is connected to the receiver 140, whether in advance of receiving the signal from receiver 140 or after receiving this signal. Display screen 110 can be any public digital display, including but not limited to television screens banners, or movie screen.

FIG. 1B shows an exemplary method for the advertisement display process according to the present invention. In stage 1, the receiver periodically requests an advertisement from the server. In stage 2, the server checks to see whether a local advertisement exists (as described in greater detail below, the local advertisement is one that is provided or selected by the owner of the public display that is connected to the receiver). In stage 3, if the local advertisement exists, then the server sends it to the receiver. In stage 4, if there is no local advertisement, then the server optionally performs the real time bidding process. If, after this bidding process, the advertisement and the time slot are available, then the server sends the advertisement to the receiver in stage 5. The receiver then causes the advertisement to be displayed in stage 6. The receiver then preferably acknowledges receipt of the material to the server, which may then optionally run part of the algorithm again, for example to update the amount of payment required for the advertisement. The priority between stage 3 and stage 4 can be replaced or adjust by another algorithm. For example, in some situations an external advertisement from an external advertiser is provided even if a local advertisement exists; for example, the selection of external or local advertisement may optionally be determined according to a balance between these two types of advertisements.

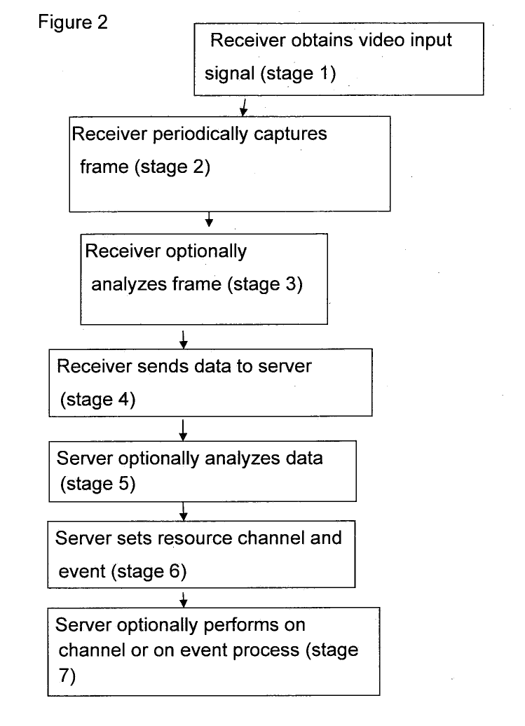

FIG. 2 is an exemplary flow describing the scenario in which a key event is identified. Key event is an event which optionally attracts a big audience and in which advertisers wish to advertise their product. Key event can be, for example, a goal in football game, a declaration of a winner in a contest, an identification of a broadcasting channel and the like. Key event detection is optionally and preferably used in on event and/or for on channel bids. Key events are optionally found by the learning engine, which is part of the receiver and/or part of the server as previously described. The receiver monitors the input signals of the display for determining key events. The machine learning engine is optionally and preferably triggered by a machine learning trigger which requests the evaluation of ongoing video content, for the detection of key events and alerts when new valuable information was detected.

Referring now to the drawing: the receiver obtains a video input signal from the public display (stage 1). From this signal, the receiver periodically captures a frame (stage 2). The receiver optionally analyzes the frame, for example to detect the event or at least to reduce the amount of data (stage 3). The receiver then sends data to the server (stage 4), which may optionally be the frame itself and/or the analyzed data. The server then optionally analyzes the frame and/or data (stage 5). According to this analysis, the server determines the channel of the resource (ie the television channel being broadcast) and whether an event is occurring (stage 6). The server optionally starts operating an on event and/or on channel bidding algorithm regarding the specific event and the specific public display (stage 7).

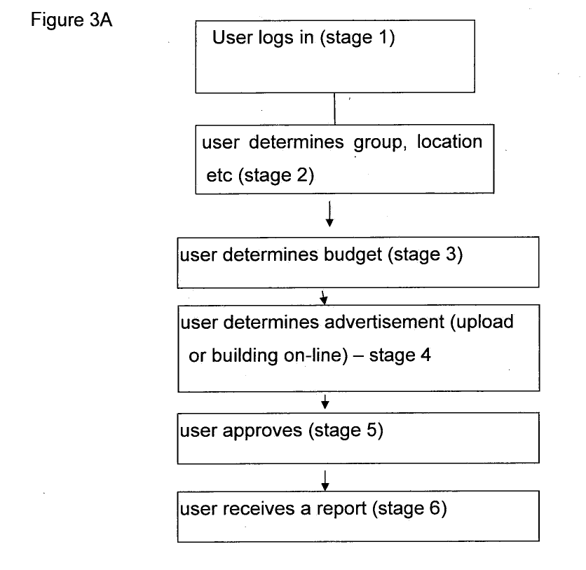

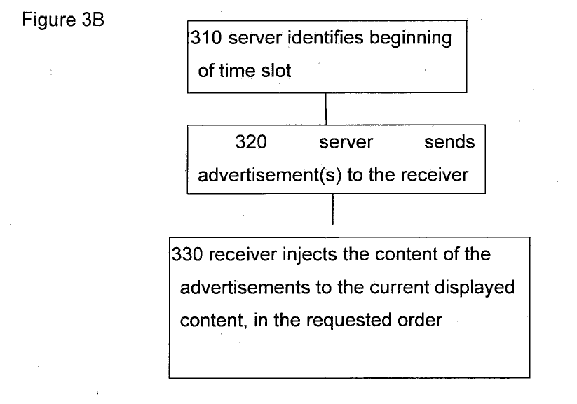

FIGS. 3A and 3B are exemplary flow diagrams describing the scenario of On Resource bid. On resource bids are preferably divided into two groups: bidding on specific resource or bidding on group of resources. The on resource bids are optionally for a given time period or epoch which can optionally be a defined period of time in the future, for example, a day, a week or four hours. The on resource bids preferably allow the advertiser to choose the advertisement and the budget, and also optionally one or more of the specific resource, type of resource or group thereof, the scope of time (time slot) in which the advertisement should be displayed and Dollar per Minute Limit (DPML). The latter parameter refers to any cost limit per unit time which allows the advertiser to monitor cost so that the advertisement is not shown if the charge per unit time is higher than the limit. The budget may optionally be limited according to any unit of time and/or campaign limit.

In the case of bidding on a resource group, the resources are preferably divided into a plurality of groups such as pubs, restaurants health club places and the like. Each resource is preferably specified by its name and location. For bidding on a resource group, instead of bidding on a single resource the bidding is done on a plurality of such resources; for example the bidding can be on all restaurants in Manhattan, or on a weighted group of resources which are primarily in a particular geographical area and/of a particular geographical type. Thus the advertiser preferably provides the location and the resource group in addition to all the other parameters. According to this embodiment the budget is preferably distributed between various resources according to an algorithm which maximizes the advertiser's exposure and utility, when the latter is based on the interests of the advertiser. According to this embodiment, the advertising on each resource is optionally and preferably divided into time slots (intervals). Each time slot preferably and optionally has its own advertising price. Advertising on peak hours (for example at the afternoon time in a haircut, or at night in a pub) is preferably more expensive then advertising in other time.

Payment may optionally be made through a credit system which may, for example, be specific to the system of the present invention and/or operated through the system of the present invention.

Referring now to FIG. 3A, in stage 1, the user (advertiser) logs into the system for bidding according to the present invention. The process may optionally and preferably be performed through a web-based interface, such as any type of mark-up language interface for example. In stage 2, the user may optionally select a group, location or any other parameter or set of parameters for determining the public display(s) (or resources) on which the advertisement is to be displayed.

In stage 3, the user determines an overall budget, which as described in greater detail below may optionally include one or more limitations (for example, the maximum amount of money to be spent per unit of time). In stage 4, the user determines the advertisement to be shown, whether through uploading or building on-line, or a combination thereof. In stage 5, the user approves of the information entered. In stage 6, after the advertisements have been shown, the user preferably receives one or more reports with regard to when and where it was shown, optionally with a statistical analysis and detailed cost price of the displayed advertisements.

Referring now to FIG. 3B, when the server identifies one or more time slots (310), the server sends one or more advertisements to the receiver, optionally in response to a request from the receiver (320). If a plurality of advertisements is sent, then also the order is preferably sent and optionally the expected delay time between each advertisement is also sent. The receiver inserts the advertisement content to the current displayed content in the order requested (330). The receiver then preferably acknowledges receipt of the material to the server, which may then optionally run part of the algorithm again, for example to update the amount of payment required for the advertisements.

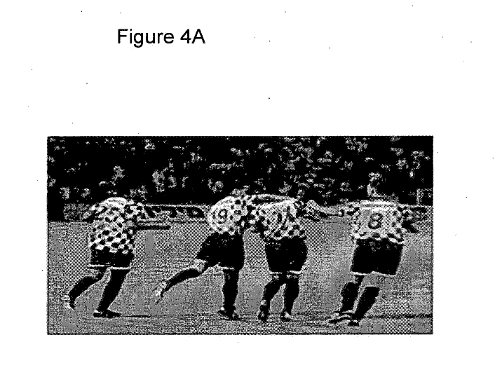

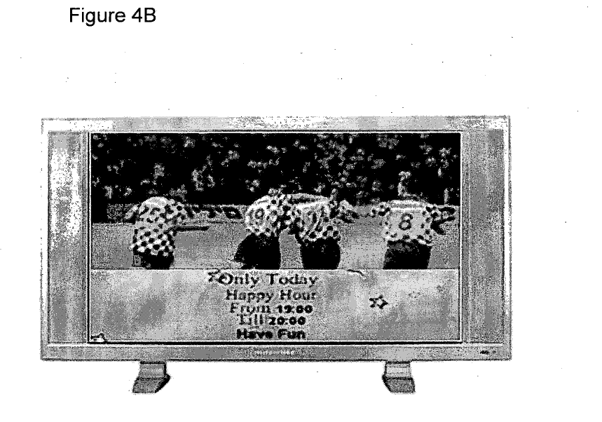

FIG. 4 is an exemplary picture of a television display, before the advertisement is displayed (FIG. 4A) and after the advertisement is displayed (FIG. 4B). The display features a receiver which is connected to the video in and video out channels of the television set and to a computer network like the internet. The advertisement is shown as being embedded in the broadcast video content.

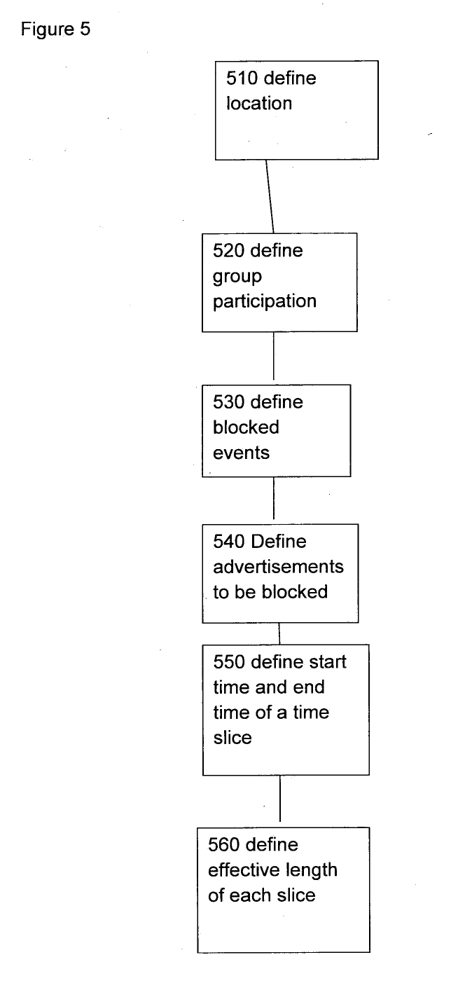

FIG. 5 is an exemplary scenario for configuring the resource parameters in the server. A resource is the business which facilitates the display on which advertisements are displayed. Such businesses can be a pub, a restaurant, a clinic and the like. Configuring the resource's parameters is required for the bidding. In the drawing first the location of the drawing is provided (510). For example a restaurant location can be a city such as New York, a big place such as a specific airport and the like. Location is used for enabling the advertisers to focus on locations of their interest. For example a restaurant would probably like to advertise in the neighborhood of the business. Next the group is optionally defined (520). As explained before, the resources are preferably divided into groups such as pubs, restaurants, health clubs and the like, in order to assist selection of suitable local resources by advertisers. A business (resource) may optionally decide whether to belong to a group and if so to what group/s to belong; alternatively, the decision regarding a particular group may optionally be made for that business, for example by the system itself according to the present invention. For example, a restaurant could join one or more groups, according to location (city, portion of a city, geographical area etc), type of business (places to obtain food and drink, or places of entertainment, or restaurants—or a combination thereof). Each group may also optionally have subgroups, such that a local resource could belong to multiple groups and/or subgroups.

Next events to be blocked are defined, for example, a pub might not be interested in publishing an advertisement when a beauty contest is displayed (530). Next advertisers and/or types of messages that cannot advertise (should be blocked) on this resource are optionally defined (540). For example a pub might not be interested in advertisers for baby needs or receiving other pubs advertisements. Next the time slots are defined (550). This definition is used for on resource bidding. Next the effective length of each slot is defined, as the maximum amount of time per time unit that one or more advertisements may be shown (560). Optionally the time slots may be predefined, by the advertisement provider, and/or by the owner of the public display space and so forth; alternatively, the time slots may be defined on the fly, according to available content and bid prices. It should be noted that the order of configuration is provided as an example only and that any other order can be used. It should also be noted that other parameters can be used for configuring the resource.

FIG. 6 is a flow chart describing an exemplary, illustrative embodiment of an algorithm that is used for the multi-resource bidding. Other algorithms may optionally be used for bidding on a single resource. The algorithm takes into consideration at least the budget of each advertiser, the bidding, and the popularity of the resource, the resource owner preferences, and the resource popularity given by the system. The specific functions shown are intended as non-limiting, illustrative examples only. The entire process is scalable and is robust to real time changes in parameters. In the drawing, first the algorithm preferably calculates the interest (one or more financial parameters) of each advertiser on the members of this group of resources. The group can have one or more resources (610). The calculation is preferably and optionally done by the function described hereinafter, though other functions can optionally be used;

$${\sum }_{r ∈ group} \frac{{I}_{c , r} \cdot {bid}_{r , c}}{{\sum }_{d ∈ agents} {\sum }_{r ∈ group} {bid}_{r , d}}$$

where I expresses the interest of the advertiser (agent) (c) in the resource (r) and bid is the amount of money placed by advertiser (d) on resource (r). The identity of the advertiser (bidder) is preferably not taken into consideration in order to ensure neutrality. Next, in order to ensure optimal distribution, the derivatives for each bid on each resource are optionally and preferably used and are set to zero. Setting to zero in this example also obtains the maximum value because the function is concave (620). The calculation is preferably and optionally done by the function described hereinafter, though other functions can optionally be used;

$$\frac{d utiltiy}{d bid} = {( \frac{{I}_{c , r} {bid}_{r , c}}{{\sum }_{d ∈ agents} {bid}_{r , d}} - {bid}_{r , c} )}^{′} = 0$$

$$\frac{{I}_{c , r} ( {\sum }_{d \neq c} {\sum }_{r} {bid}_{r , d} )}{{( {\sum }_{d} {bid}_{r , d} )}^{2}} = 1$$

where I is the interest of the advertiser (c) in the resource (r) and bid is the amount of money placed by advertiser (d) on resource (r). This describes the derivative of agent interest in the bid made by that agent (advertiser). After combining all equations for a given resource the following equation is obtained for each advertiser:

$${I}_{c , r} {\sum }_{d \neq c} {\sum }_{r} {bid}_{r , d} = {( {\sum }_{d} {bid}_{r , d} )}^{2} = {α}_{r}^{2} .$$

Alpha-r (αᵣ) is an estimated sum of all of the bids on the specific resource to estimate the popularity thereof.

Next the combination of bids that ensure all advertisers that their derivatives are zero is found. These functions are optionally and preferably calculated as described hereinafter (though other functions can optionally be defined). First a matrix is defined where N is the number of advertisers.

(JIₙ−1ₙ))·bids=[αᵣ²]ₙ^{t}

When the JI matrix is the matrix where in row c there is a single element I_{c,r} on the entire row and 1ₙ is the sized n unit matrix, wherein each row represents the interest of the advertiser in a particular resource, while each column represents the interest from all advertisers in a particular resource. There is preferably a different matrix for each resource. As a result from the 1ₙ subtraction, a matrix is obtained that has 0 in the main diagonal; this matrix represents the best bids for the maximum utilization. (Derivation equals to 0 brings the maximum)

$$( \begin{matrix}01111 \\ 50555 \\ 33033 \\ 88808 \\ 77770\end{matrix} ) \begin{matrix}Interest of the first advertiser on this resource is 1 \\ … \\ … \\ … \\ Interest of the fifth advertiser on this resource is 7\end{matrix}$$

The solution to this equation system is always unique (full rank matrix), and is equal to:

$${bid}_{c , r} = {\sum }_{d} \frac{{α}_{r}^{2}}{( n - 1 ) {I}_{d , r}} - \frac{{α}_{r}^{2}}{{I}_{c , r}}$$

In order for the bids to sum up to the budget, an adjustment constant C_{c} is preferably added which multiplies the interests (630). This adjustment prevents any possible gain by scaling the interests on a different scale, as the interest will now be I_{c,r}/C_{c}. Thus, the bid of advertiser or agent (d) on the resource (r) (which is a member of the resource group) is equal to the following equation, including interest and so forth, which calculates bids of the advertisers on each of the resource group members (640):

$${bid}_{c , r} = {\sum }_{d} \frac{{C}_{d} {α}_{r}^{2}}{( n - 1 ) {I}_{d , r}} - \frac{{C}_{c} {α}_{r}^{2}}{{I}_{c , r}}$$

To satisfy the sum of budget constraint the sum of budgets must fit:

$${\sum }_{r} {bid}_{C , R} = {\sum }_{r , d} \frac{{C}_{d} {α}_{r}^{2}}{( n - 1 ) {I}_{d , r}} - {\sum }_{r} \frac{{C}_{c} {α}_{r}^{2}}{{I}_{c , r}}$$

The solution to this set of equations also always exists and unique, and equals to:

$${C}_{c} = \frac{{\sum }_{c} {bud}_{c}}{{\sum }_{r} \frac{{α}_{r}^{2}}{{I}_{c , r}}}$$

The denominator in the equation describing C_{c} is referred as harm_{c}. Provided there is a good heuristic estimate on αᵣ, which should be equal or close to the sum of bids on this resource (as said before it's the popularity of the resource), there are bids which will fit to the budget. This process preferably ensures stability, under the assumption that there is a good heuristic for αᵣ, since the interest (which is expressed in the “I” parameters) for all advertisers is maximized. To ensure positive values, the ability for an advertiser to place a bid only on a subset of group members and the ability of an advertiser to prevent certain advertisements from being shown, the following modifications are performed. If the interest is at its minimal value (currently one) then the bid is automatically set to zero (650). If a bid is negative, it is zeroed out (660). Next the results are divided or multiplied in order to reach a total sum that is less than or equal to the total budget. The result enables the screen owner to optionally prevent certain advertisements from being shown (670). Also optionally the advertiser may optionally place a bid only on certain selected the group resources. Only non negative bids are allowed. Next, the positive bids of the advertiser are arranged so that the sum total of all bids is no greater than the original budget limit (680) by means of multiplying by a fixed number. In this manner bids are obtained by the advertisers on each member of the resource group (690). This algorithm preferably fulfills the requirements described hereinafter, although such requirements are not an absolute and may optionally be changed or removed:
Neutrality is satisfied by ignoring the identity of the advertisers, for example to avoid explicit or implicit brand preferences
Non negative—bidding
maximizes the advertisers' gain according to their interests
Stability—There is no realistic way to cheat the algorithm and get more air time with less money
Increased budget leads to increased impact.

In the case of placing a bid on a single resource, optionally only a small part of the algorithm is being used. The system preferably checks whether the bidding advertiser is not blocked by the resource owner. If so this bid is accepted, and is saved in the database. In the case that the relevant advertiser is blocked on the relevant resource this bid is canceled.

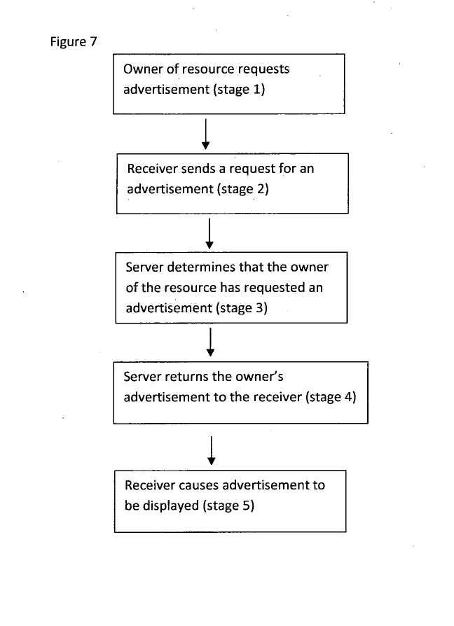

FIG. 7 shows an exemplary embodiment of a method for permitting the owner of a resource to cause a particular advertisement to be displayed through the resource, as a “local advertisement”. In stage 1, the owner of a resource requests that a particular advertisement be displayed on the resource, preferably through a web-based interface. The request is made to the server, and may optionally include sending a particular advertisement and/or building the advertisement through the web-based interface. In stage 2, the receiver at the resource periodically sends a request to the server for an advertisement, preferably without being aware of whether a local or other type of advertisement is available. In stage 3, the server determines that the owner of the resource has requested display of a particular advertisement. In stage 4, the server returns the owner's advertisement to the receiver. In stage 5, the receiver causes the advertisement to be displayed. The receiver then preferably acknowledges receipt of the material to the server, which may then optionally run part of the algorithm again, for example to update the amount of payment required for the advertisement or to update the reports of the shown advertisements.

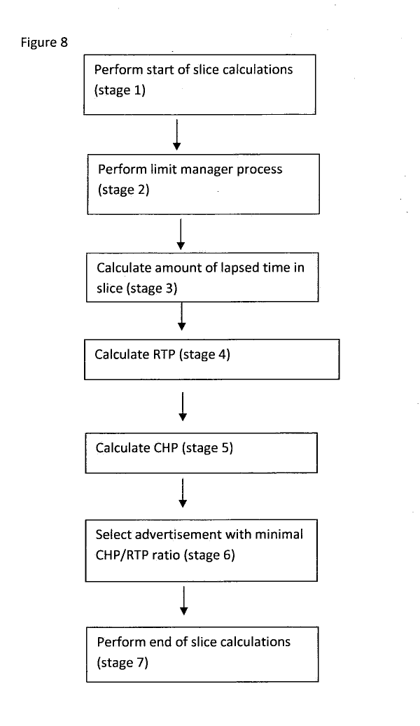

FIG. 8 shows an exemplary embodiment of a method for selecting one or more advertisements for display in real time. As shown, in stage 1, start of slice calculations are performed, at the start of a period of time during which one or more advertisements may be shown, which is known as a “slice”. At the start of the slice, preferably all previous slices on the same resource (public display) are ended. Next, the “on event” bidding algorithm is preferably run as previously described.

In stage 2, the limit manager process is preferably operated. This process is also preferably performed after a change of some type in the resource (for example, switching channels or having a new event start). Advertisers set the maximal price per minute at which an advertisement may be shown. The limit manager is a mechanism that determines in real time which advertisements are to be shown and the DPM (dollar per minute or other time period) to be charged, making sure that this constraint will be met. Additionally, it performs a cut high, not allowing any single bid to receive more than 50% of the total budget placed, provided that there is at least a certain (defined) number of bids.

The input to this process preferably includes the following data:
Advertiser Identification (i)—Identification of the advertiser to refer to its data
Advertiser Bids—bi—The bid of the advertiser on the current time slice (or slice fraction) of the resource. Those bids consist also of unused bids from previous steps on the slice.
Advertiser Interest Start—ti—The time in the slice that the advertiser is interested in advertising on the screen. This can be denoted as the “start time”—the time the advertiser started its interest in the resource.
Advertiser DPM Limits (DPML)—lᵢ—The limitation on the “per minute price” (DPM—dollar per minute or other time period).

These inputs are then processed as described above, in order to determine whether an advertisement may be shown during a particular slice, according to the value of the slice at that particular time (as described in greater detail below, the value of the slice changes over time).

In stage 3, the amount of time elapsed in the slice is calculated, preferably with regard to the amount of advertising already shown. In stage 4, the RTP (relevant time percentage) is calculated, which is the amount of time required for a particular advertisement divided by the total amount of advertising time that is still available in the slice. In stage 5, the CHP (charge percentage) is calculated, which is the amount of bid for displaying a particular advertisement at a particular time, divided by the total value (or potential bids) for the slice. If possible, it is preferred that RTP and CHP remain constant or at least proportional throughout the slice, although this is not an absolute requirement. Preferably, the advertisement that is selected has a minimal CHP/RTP ratio in stage 6.

In stage 7, preferably the end of slice process is performed at the end of the slice. This process preferably includes determining which advertisements are sufficiently short so as to be potentially displayed and also adjusting the CHP to account for the amount of time remaining.

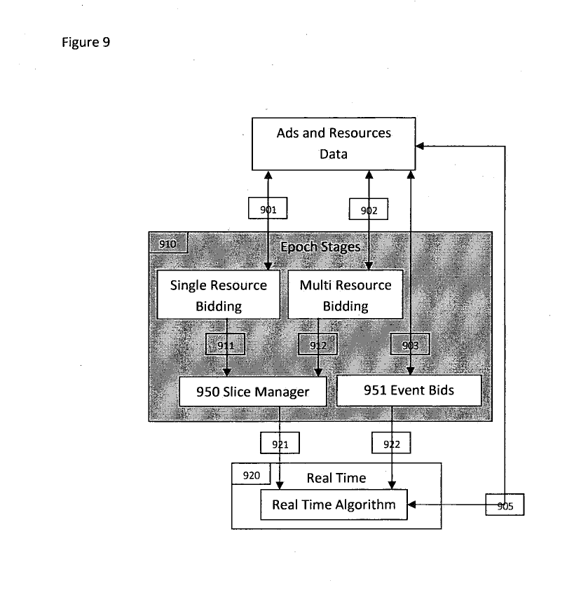

FIG. 9 is a diagram describing the architecture of an exemplary embodiment of the system according to the present invention. The system architecture is optionally and preferably divided into two main parts. The first part is the bidding algorithm 910 that runs periodically, for example once a day, week etc and handles the bids. The other part is the real time algorithm 920, which runs in real time and handles requests for advertisements. Bidding algorithm 910 is required in order to handle the resource requests for advertisements. According to one embodiment of the present invention the advertiser can place three main types of bids. The single resource bid module 901 optionally and preferably, enables the advertiser to place a bid on a single resource. The multi resource bids module 902 optionally and preferably enables the advertiser to place a single bid on a set of resources. The event bids handler 903 preferably handles bids on a plurality of events that may occur during an epoch. Each bid type is handled by a different part of the algorithm. Information regarding the single and multiple resource bids are obtained from the database (901, 902 respectively). This input (911 and 912) is transferred into the slice manager (950). The bids are distributed among slices, and transferred to the Real Time Algorithm 920. Event bids are set be effective when the event occurs, on the resources that the advertiser placed an advertisement, providing that the event and the advertiser are not blocked. In these cases, the data of the event bids is transferred to the Real Time Algorithm 920. The Real Time Algorithm 920 receives as input advertisements and resource data 905, slice bids 921, and event bids 922. Real time algorithm 920 preferably operates when a resource requests an advertisement, or an event is changed on the resource. The results of the algorithm are updated in order to provide reports and adjustments in various parameters, such as the probabilities of events, usage, broadcasted advertisements, charges and more. Some of the results are updated in real time, whereas some when the slice or epoch ends.

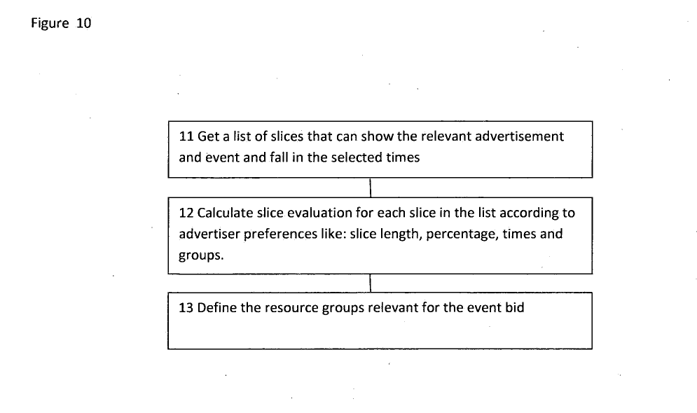

FIG. 10 is a diagram of the event bid handler. According to one embodiment of the system, advertiser can place a bid on an event, such as a soccer game for example. Additionally, the advertiser can choose the location and/or one or more of the resource groups (e.g.: pubs and restaurants in a specific city that will show a specific soccer game) in which the advertiser would like the advertisement to be displayed. When the bid is placed, or optionally after the bid is placed, the event bid handler is executed. The event bid handler handles the event bid for the advertiser and prepares it for the next stage in the real time algorithm. The event bid handler enables the advertiser to optionally set a preferred own start and end time of the bid. For example, if the event of a soccer game is from 20:00 PM till 22:30 PM, the advertiser can optionally set it to any interval within this period, such as, for example 21:00 PM till 22:00 PM. Upon setting the start and end time of the bid, the event bid handler preferably finds all the relevant slices for this time slot, which are not blocked by the resource owner optionally with regard to the relevant event and/or the relevant advertiser (11).

Next, the event bid handler evaluates each of the slices (12). The slice evaluation is a number which relates to the relative value of the slice, compared to other slices, where this bid is handled. The slice evaluation is affected by many parameters, including but not limited to one or more of a slice factor (which may optionally for example relate to the general perceived value of the time and/or location), advertisement factor (which relates to the interest of the advertiser in the time and location), the value of the resource, event slice probability, and slice length. The slice evaluation number represents the interest of the advertiser is in the slice, compared to other slices of the same resource or other resources. The slice evaluation number represents the advertiser preferences and does not necessarily affect other advertisers.

In the next stage the system selects the resource groups and locations that are relevant to the event bid, for example according to the interest of the advertiser (13). This data optionally and preferably enables the system to update slice valuations if the resource changes to a different group and to provide information to the advertiser regarding the event bids that are relevant to this resource. The output of the event bid handler preferably provides all the data required for the real time stage algorithm, enabling the advertisement to potentially be displayed whenever the event chosen by the bid occurs in the chosen resource. Additionally, the slice evaluation defines the interest of the advertiser in the slice (or slice remainder thereof), and enables the system to calculate the budget of the bid for the advertiser on the slice. The event bid handler ensures that advertisements that are blocked by the resource owner will not be displayed and events will be blocked when required by the resource owner.

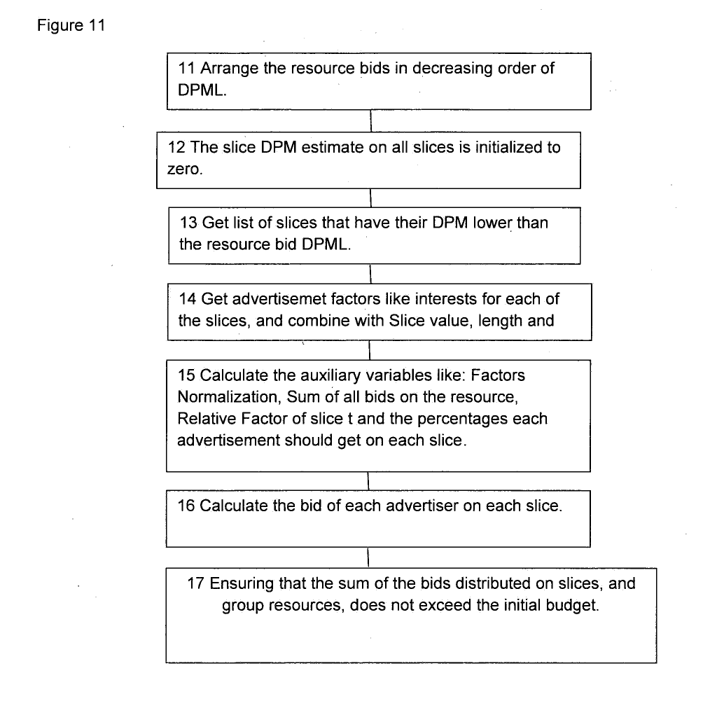

FIG. 11 is a diagram describing the slice manager according to one embodiment of the system. After obtaining the on resource bids, the system optionally and preferably, distribute the budget among time intervals on the epoch. Each resource has different time slices, as the resource value varies throughout the time of the day. As the time value differs throughout the epoch (e.g. day). The system optionally and preferably divides the time value into time slices, such that each time slice represents one value of a resource. The slice manager can optionally assign different intervals to different resources. This embodiment enables the system to adjust the charge to the popularity of the resource, on a given time. This slice manager is activated per resource therefore, bids placed on one resource will not affect the slice manager activating on a different resource. Referring now to the drawing: First the slice manager arranges the bids placed on the resource in decreasing order of DPML (Dollar per Minute Limit) (11). Next, the slice DPM estimate on all slices is preferably initialized to zero (12).

The following stages are preferably activated for each resource separately (bids originated by the same company and having the same advertisement can optionally be merged into a single bid, although alternatively each bid can be treated separately). Furthermore, from stage 13, the process preferably loops each time on a single bid. First the slice manager arranges a list of slices with DPM lower then resource bit DPML (13). Preferably only the relevant slices are selected, in terms of time, availability at the resource and so forth.

Next the slice manager calculates the values for each of the slices in the list for the advertiser (14). Calculation is done based on parameters such as relevant group, start and end time and value. Each resource group has a predefined value for the various times of the day, to describe its popularity. For example—a pub may optionally have a higher evaluation for evening hours than for morning hours. Each slice value has a slice factor and advertisement factor as previously described. The advertisement factor is provided by the advertiser, while the slice factor may optionally be statically or dynamically defined. The slice length and advertisement percentage (the percent of time during the slice show ads) may optionally be calcualted. Then these and other parameters are combined, for example by geometric average, in order to determine the relative slice value for the advertiser.

Next the Auxiliary Variables are optionally calculated (15). The calculation is preferably done based on the following formula:

$${C}_{c} = {\sum }_{t} {F}_{c , t} \cdot {L}_{t}$$

$$SB = {\sum }_{c} {B}_{c}$$

$${F}_{t} = {\sum }_{C} \frac{{B}_{c} \cdot {L}_{t} \cdot {F}_{c , t}}{SB \cdot {C}_{c}}$$

$${P}_{c , t} = \frac{{F}_{c , t} \cdot {L}_{t} \cdot {B}_{c}}{SB \cdot {F}_{t} \cdot {C}_{c}}$$

when c is the company index and t is the slice index:
C_{c}—Factor Normalization Constant for company. This prevents any bid from rescaling the parameters provided by the advertiser.
SB—Sum of all bids on the resource
Fₜ—Factor of slice t—sets an importance for the slice.
P_{c,t}—the percentage of ad c on time slice t.

Next t the bid of the company c is set on slice t to:

B_{c,t}=Fₜ·P_{ct}·SB
If the auxiliary constants are of no interest, the same result may optionally obtained by calculating only the Normalization constant and the bids (stage 16), for example according to the following function:

$${B}_{c , τ} = \frac{{F}_{c , τ} {B}_{c} {L}_{τ}}{{C}_{c}}$$

Next the amount is preferably adjusted, for example by rounding down, to ensure that the sum of the bids distributed on slices, and group resources, does not exceed the initial budget (17).

The slice manager ensures independent results per each resource (by activating the algorithm separately per each resource). The slice manager also ensures that bidding will take place only on slices within the DPM limit (DPML). In addition, the parameters provided by the advertiser, such as the advertiser's interests in slices, only affect the budget distribution for that advertiser and have no affect on bids of other agents (advertisers), except for the DPML.

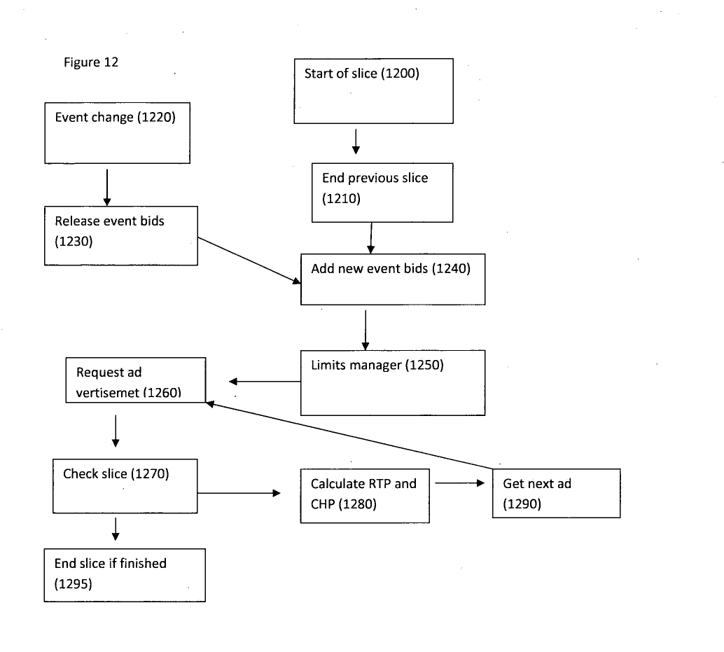

FIG. 12 is a diagram describing the real time manager according to one embodiment of the system. The real time manager is activated every time a resource requests for an advertisement. This process is an exemplary, illustrative only method and may optionally be changed. Referring now to the drawing, the process may optionally start with the start of a slice (1200), after which the previous slice(s) are ended (1210), or if the event is changed (1220), after which the previous event bids are released (1230), as the previous event is no longer the current event on the resource. The real time manager transfers preferably the unused money from the previous event for future use. The slice may optionally be started due to a request for an advertisement.

Next, new event bids are added for the new event (1240). The fraction that the bid will be of the reminder of an event bid budget may optionally be calculated applying the following formula, which describes the amount placed on the current slice as bid and the amount to be saved for the future:

$${\sum }_{i} {{b}_{i} ( \frac{Current\_Evaluation}{Current\_Evaluation + \sum ( Future\_Evaluation \text{-} Probability )} )}^{{α}_{t}} , \\ \sum {b}_{i} = 1 , 0 < {a}_{i} \leq 1$$

The limits manager reviews the bids with regard to the budget as previously described (1250) and also adjusts the DPML. It is set to be at most [bid/(0.5*ad length)]. This is done in order to prevent an ad placing a bid too small to be shown even once in the slice. For example, if the advertisement length is 0.15 minutes, the bid is 10$ and the DPML is 150$, the maximal DPM is determined at which 10$ will be enough to show 0.5 (defined number) of the ad:

10/(0.15*0.5)=133⅓

Thus, the DPML of the advertisement is adjusted to be at most 133⅓, and as it is less than the current DPML (=150), the new DPML of the ad will be 133⅓.

Then the bids are placed in decreasing order by DPML. Bids are added to the shown pool while the sum of bids divided by advertising time (or its reminder, called the DPM) is lower than the DPML of the bid to be added. Once the limit has been reached, as much of the bid as possible is used, while the remainder will be saved as “unused bid”.

The limit manager then performs a “cut high” process, to determine whether there is a bid that has more than 50% of the sum of all bids. If so this high bid is adjusted to the sum of all other bids. Then the process of adding bids is repeated, when for every amount added, a similar amount is added to the bid that was reduced during the “cut high” process. This process enables the highest maximal sum of bids on the slice to be obtained.

The limit manager also determines whether there is sufficient time left in the slice to add another advertisement.

An advertisement is then requested (1260). The slice is checked to see whether it is continuing or has ended (1270); if the slice has finished, then the process ends (1295). The charges to each advertiser are then adjusted so as not to exceed the bids, any unused money is returned and so forth. Such adjustments are made so that any such charges are reduced to be as minimal as possible.

If the slice is not finished, then preferably it is determined whether an advertisement may be broadcast (for example to make certain that there are not too many advertisements already scheduled to be shown during a particular time period); if so, then the RTP and CHP are calculated (1280). RTP (relevant time percentage) is calculated according to the amount of relevant advertising time is required to show the advertisement divided by the total advertising time that has expired from slice start time up to now. CHP (charge percentage) is calculated according to the ratio of the bid already charged (by estimate) from the total bid, and the total bid on the slice. The next advertisement is obtained by selecting the advertisement with the minimum ratio of CHP to RTP (1290), after which the process may optionally return to requesting an advertisement (1260).

It should be noted that if there are no events, the above process may optionally be altered as follows. The order of bids may optionally be determined at a particular time each day, or periodically, or as desired, without necessarily being constrained to be performed as each slice starts, for example. The time that each advertisement should be shown is equal to (bid)/(sum of bids)*(advertising time of slice). If this calculation causes some of the available advertising time to remain unused, optionally the “sum of bids” parameter is reduced until the total available advertising time is filled; in this situation, the DPM is calculated as (reduced sum of bids)/(advertising time). The advertisements are then preferably arranged according to any type of order or randomly, although optionally, a machine learning mechanism can be used in order to sort the advertisements, in order to minimize such unused times, based on the history of the behavior of the system in such scenarios.

According to some embodiments, the unit associated with the local resource (ie the local display, such as a television set for example) is optionally able to interact with cellular telephones present at or near the location of the local resource. For this embodiment, the unit preferably includes a cellular module, which can accept SMS (short message service) messages. Using these messages, individuals present at the location of the local display may optionally ask for any type of media to be played on the local display, including but not limited to audio, video, text and the like, for example relating to songs, movies, games, personal messages, and so forth. The unit may also optionally support gambling activities (or skill based ones, such as quizzes). The payment is preferably made through the mechanism of the SMS itself as charged by the cellular carrier (ie a fee for sending the SMS). The number to which the SMS is to be sent, optionally with other relevant directions, appears on the local display (displayed from time to time according to instructions from the unit itself). Alternatively, the server may be in contact with the cellular carrier, in which case the unit does not need to have the cellular module.

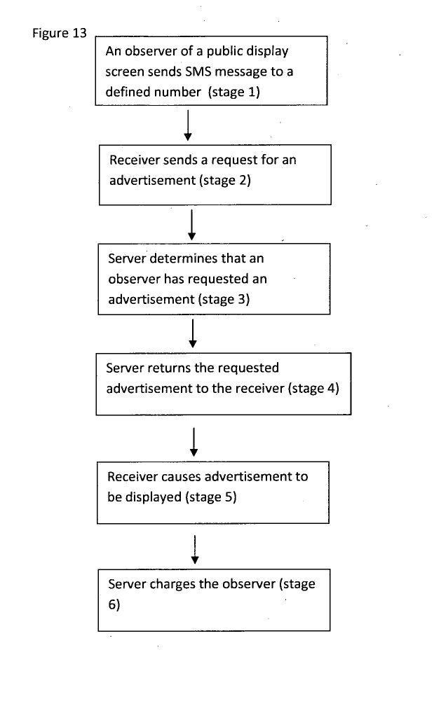

FIG. 13 shows a flow chart of an exemplary method for interaction between wireless devices, such as cellular telephones, and the system of the present invention in some embodiments, through SMS messages. In stage 1, an observer of a public display screen sends SMS message to a defined number, for example through a wireless device although optionally through any other mechanism (for example, from a computer through a computer network such as the Internet). In stage 2, the receiver sends a request for an advertisement, preferably periodically. Stages 1 and 2 may optionally be in any order or may be simultaneous.

The server receives this request from the receiver but also determines that the observer has sent an SMS message in stage 3. In stage 4, the server returns the requested advertisement to the receiver. Next, in stage 5, the receiver causes advertisement to be displayed, optionally and preferably sending an acknowledgement of the display of the advertisement to the server. In stage 6, the server charges the observer, for example through a cellular telephone subscription.

Payment may optionally be made through an SMS directly, or through any other pre-paid mechanism (sending a “regular” SMS with a pre-paid code as the prefix of the message, or as a part of the destination number), or in any other way (credit cards, any type of pre-paid system or service (including but not limited to Paypal® and the like), and so forth).

While the invention has been described with respect to a limited number of embodiments, it will be appreciated that many variations, modifications and other applications of the invention may be made.

1. A method for distributing an advertisement to at least one public display screen comprising:
a) Selecting an advertisement according to at least one characteristic of the at least one public display screen and according to at least one financial parameter;
b) Combining said advertisement with video data from a source other than a source for said advertisement for display on the at least one public display; and
c) Displaying said advertisement and said video data on the at least one public display.

2. A method for distributing an advertisement to at least one public display screen, the at least one public display screen displaying broadcast video data and the at least one public display screen having a receiver, the method comprising:
a. Selecting an advertisement according to at least one characteristic of the at least one public display screen and according to at least one financial parameter, said advertisement being received separately from said broadcast video data;
b. Combining said advertisement with the broadcast video data for display on the at least one public display by said receiver; and
c. Displaying said advertisement and the broadcast video data on the at least one public display.

3. A method for distributing advertisements on a public display screen having a receiver, the method comprising:
a. determining advertisement time slots for said public display screen;
b. selecting from a plurality of different advertisement content items to display during said time slots; and
c. selecting an advertisement content item from said plurality of different advertisement content items according to at least one characteristic of the public display screen for combining by said receiver.

4. The method of claim 3 further comprising:
d. assembling sequence of advertisements to air during said time slots;
e. sending at least one advertisement to said public display screen; wherein said assembling said sequence of advertisements comprises: determining beginning of a time slot; airing an advertisement in said broadcast sequence; determining an end of said time slot; and repeating for said sequence of advertisements.

5. (canceled)

6. (canceled)

7. The method of claim 3 wherein said advertisement content is determined based on one or more of the content broadcast on said public display, the location of said public display or a group type of said public display.

8. (canceled)

9. (canceled)

10. The method of claim 3 wherein said time slots are determined by the owner of a public display screen.

11. The method of claim 3 wherein said time slots are determined by the location and/or displayed content and/or group type of said public display screen.

12. The method of claim 11 wherein said advertisement content is chosen from the media group consisting of audio, video, text, animation or scent, or a combination thereof.

13. The method of claim 12 wherein said time slots are determined manually.

14. The method of claim 1 wherein said advertising content is determined based on parameters associated with said public display screen.

15. The method of claim 1 wherein said parameter is selected from the group consisting of location, content, group type and audience of said public display, or a combination thereof.

16. The method of claim 1 wherein said public display is located at locations chosen from the group consisting of a health club, pub, hospital, restaurant, medical clinic, waiting room, airplane, train, bus, casino or store.

17. A system for distributing advertisements on a public display screen comprising:
a. a public display screen to display broadcast or local media;
b. a receiver to receive said advertisements located at said public display screen for being combined with said broadcast or local media, wherein said receiver comprises a learning engine for determining the onset of an event; and
c. a server to select said advertisements for said receiver specifically, wherein said server comprises a decision engine for determining said advertisement distribution and wherein said decision engine utilizes an auction to determine said advertisement distribution.

18. The system of claim 17 wherein said public display is located at locations chosen from the group consisting of a health club, pub, hospital, restaurant, medical clinic, waiting room, airplane, train, bus, casino or store, or a combination thereof.

19. (canceled)

20. (canceled)

21. The system of claim 17 wherein said receiver identifies the onset of an event based on the broadcast signal on said public display.

22. The system of claim 17, wherein said server identifies the onset of an event based on the broadcast signal on said public display.

23. The system of claim 21 wherein said event identification is communicated to said server by said receiver.

24-58. (canceled)

59. The method of claim 1, wherein the advertisement is blended into video data for display on the public display screen.

60-61. (canceled)

62. The method of claim 1, further comprising requesting display of an advertisement by an advertiser; and displaying said advertisement on said public display in real time.

63. The method of claim 62, wherein said real time comprises up to about two days.

64. The method of claim 63, wherein said real time comprises up to about one day.

65. The method of claim 64, wherein said real time comprises up to about 10 hours.

66. The method of claim 65, wherein said real time comprises up to about one hour.

67. The method of claim 66, wherein said real time comprises up to about 5 minutes.

68. (canceled)
